(19) United States
(12) Patent Application Publication
(10) Pub. No.: US 2011/0093293 A1
(43) Pub. Date: Apr. 21, 2011

(54) METHOD AND SYSTEM FOR PERFORMING CLINICAL DATA MINING

(75) Inventors: Harikrishna Rai G. N., Bangalore (IN); Ashish Sureka, New Delhi (IN); Sivaram V. Thangam, Kanyakumari (IN); Pranav Prabhakar Mirajkar, Nasik (IN); K. Sai Deepak, Chhattisgarh (IN)

(73) Assignee: INFOSYS TECHNOLOGIES LIMITED, Bangalore (IN)

(21) Appl. No.: 12/814,564

(22) Filed: Jun. 14, 2010

(30) Foreign Application Priority Data
Oct. 16, 2009 (IN) 2520/CHE/2009

(51) Int. Cl. G06Q 50/00; G06Q 10/00; G06F 17/30

(52) U.S. Cl. 705/3; 707/776; 707/E17.014

(57) ABSTRACT

The invention provides a method and clinical data mining system for enabling a user to derive knowledge from data corresponding to a plurality of electronic health records stored in a repository. One or more data elements are provided as an input. The data elements may include textual reports, images, and one or more criteria specified by the user. Information is extracted from one or more images associated with one or more electronic health records stored in the repository, based on the data elements. Further, information is extracted from one or more textual reports and structured data associated with the one or more electronic health records. Thereafter, one or more reports are generated based on the extracted information to enable the user to analyze the information. Subsequently, the user may derive knowledge from the data based on the analysis.

### BACKGROUND

The present invention relates generally to data mining. In particular, the present invention relates to a method and system for performing clinical data mining in a healthcare environment.

Typically, a healthcare environment includes structured data such as billing information, patient schedules, and discharge summary reports; and unstructured data such as free-form textual reports and images. The structured and unstructured data often contains valuable information which when combined can be used to derive knowledge such as hidden patterns. However, clinical data mining systems that are known in the art mine data from either the free-form textual reports or images, besides mining structured data for deriving knowledge. Presently, it is difficult to derive knowledge from both free-form textual reports and images at the same time. Further, in healthcare environments, clinical researchers and medical experts often need to access historical medical records for discovering patterns and insights for use in medical diagnosis or clinical research. Therefore, to exploit all the information available, there is a need to integrate data mined from all forms of structured and unstructured data.

In light of the discussion above, there is a need for a clinical data mining system that can leverage knowledge derived by mining all forms of structured and unstructured data. Further, there is a need to integrate the clinical data mining system with existing health care database systems, such as Hospital Information System (HIS) and Picture Archival and Communication System (PACS), to enable the medical experts to access the historical medical records. In addition, there is a need to enable creation of workflows to perform key data mining needs such as quality management, disease management, and evidence retrieval.

### SUMMARY

To overcome the limitations described above, the invention describes a method and system for enabling a user to derive knowledge from data corresponding to a plurality of electronic health records stored in a repository. One or more data elements are provided as an input. The data elements may include textual reports, images, and one or more criteria. In an embodiment of the invention, the data elements may be provided by the user. One or more images and one or more textual reports are identified based on the data elements. Information is extracted from the images and the textual reports associated with one or more electronic health records stored in the repository. For example, the images and the textual reports may be identified based on a sample image input by the user and accordingly information may be extracted. Further, information is extracted from structured data associated with the one or more electronic health records. Thereafter, one or more reports may be generated based on the extracted information to enable the user to analyze the information. The reports may include one or more charts and summary reports. Subsequently, the user may derive knowledge, such as hidden patterns and insights from the data, based on the analysis. One or more workflows may also be created to perform one or more specific data mining tasks such as disease management and quality management.

Since information is extracted from the data associated with the electronic health records, knowledge may be derived from all forms of structured and unstructured data such as images and free-form reports. Further, data can be imported from existing database systems, and historical medical records may be accessed. In addition, workflows may be created to perform key data mining needs.

### BRIEF DESCRIPTION OF DRAWINGS

The various embodiments of the invention will hereinafter be described in conjunction with the appended drawings, provided to illustrate and not to limit the invention, wherein like designations denote like elements, and in which:

FIG. 1 illustrates a clinical data mining system, in accordance with an embodiment of the invention;

FIGS. 2A and FIG. 2B illustrate a method for performing clinical data mining to derive knowledge from data stored in a repository, in accordance with another embodiment of the invention;

FIG. 3 illustrates a block diagram of an image mining module, in accordance with an embodiment of the invention;

FIG. 4 illustrates a block diagram of a text mining module, in accordance with an embodiment of the invention;

FIG. 5 illustrates a block diagram of a quality management system, in accordance with an embodiment of the invention;

FIG. 6 illustrates a flowchart of a workflow of a biosurveillance agent for monitoring data stored in a repository of a clinical data mining system, in accordance with an embodiment of the invention;

FIG. 7 illustrates an exemplary architecture of a clinical data mining system, in accordance with an embodiment of the invention;

FIG. 8 is a screenshot of an exemplary user interface of a data classification module, in accordance with an embodiment of the invention; and

FIG. 9 is a screenshot of an exemplary user interface of a system for searching images, in accordance with another embodiment of the invention.

### DETAILED DESCRIPTION OF DRAWINGS

The invention describes a method, system and computer program product for enabling a user to derive knowledge from data corresponding to a plurality of electronic health records stored in a repository. One or more data elements are provided as an input. The data elements may include textual reports, images, and one or more criteria. In an embodiment of the invention, the one or more data elements may be provided by the user. One or more images and one or more textual reports are identified based on the data elements. Information is extracted from the images and the textual reports associated with one or more electronic health records stored in the repository. Further, information is also extracted structured data associated with the electronic health records. Thereafter, one or more reports are generated based on the extracted information to enable the user to analyze the information. Subsequently, the user may derive knowledge, such as new patterns and insights from the data, based on the analysis.

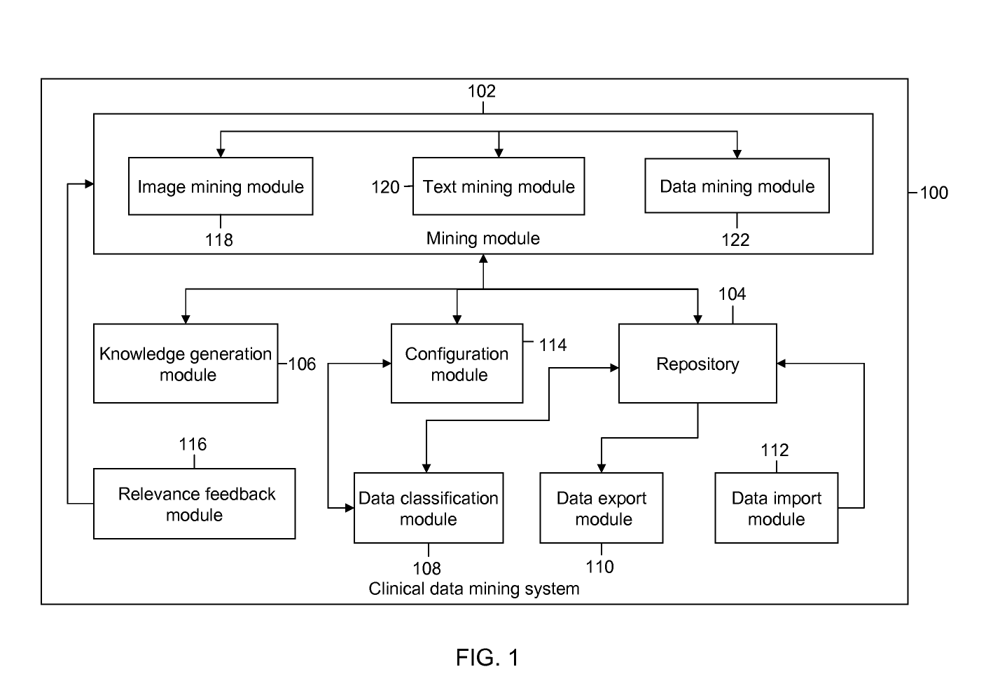

FIG. 1 illustrates a clinical data mining system 100, hereinafter referred to as CDM system 100, in accordance with an embodiment of the invention. CDM system 100 includes a mining module 102, a repository 104, a knowledge generation module 106, a data classification module 108, a data export module 110, a data import module 112, a configuration module 114, and a relevance feedback module 116. Mining module 102 includes an image mining module 118, a text mining module 120, and a data mining module 122.

Data related to a plurality of electronic health records is stored in repository 104. In various embodiments of the invention, each electronic health record may be associated with at least one of one or more textual reports, one or more images, and structured data. Further, the images associated with the electronic health records may be stored in a standard-compliant format for storing medical images such as Digital Imaging and Communication in Medicine (DICOM) standard.

One or more data elements are provided as an input to mining module 102 by the user. The data elements may include images, textual reports, and one or more criteria. The one or more criteria may include keywords describing metadata corresponding to the electronic health records. Further, the metadata may include values corresponding to one or more DICOM attributes, such as ‘Modality’ and ‘Age’. Mining module 102 extracts information from data associated with the electronic health records on the basis of the data elements.

Image mining module 118 extracts information from one or more images associated with one or more electronic health records stored in repository 104. The one or more images are identified from a plurality of images stored in repository 104 based on the data elements. The data elements may include criteria, which may be values corresponding to DICOM attributes, for example, ‘Computed tomography (CT)’ and ‘Chest’ corresponding to DICOM attributes ‘Modality’ and ‘Organ’, respectively. Thereafter, DICOM attributes corresponding to the plurality of images may be compared with the data elements to identify the one or more images.

In another embodiment of the invention, the criteria may include image features, such as shape, texture, intensity, and color. The plurality of images may then be processed using image processing techniques, such as Content Based Image Retrieval (CBIR), for identifying the one or more images. Further, image mining module 118 may assign a score to each of the plurality of images, based on their relevance with respect to the criteria, by using a similarity computation technique. The user may then identify the one or more images based on the scores. Further, relevance feedback module 116 enables the user to provide feedback on the assigned scores. The user may also modify the scores to refine the search result. The modified scores may then be stored for subsequent references. In yet another embodiment of the invention, a predefined weight may be assigned to each criterion depending on the relative importance of the criterion. For example, a weight of 0.8 may be assigned to a criterion such as ‘shape’ and a weight of 0.2 may be assigned to a criterion such as ‘color’. Thereafter, cumulative scores may be calculated for the plurality of images based on the assigned scores and the predefined weights. The user may then modify one or more weights for modifying the cumulative scores, to refine the search result. The modified weights may also be stored for subsequent reference.

Thereafter, information is extracted from the identified images based on the data elements. In various embodiments of the invention, the information may be extracted by processing the images using one or more image processing techniques such as image segmentation and edge detection.

Text mining module 120 extracts information from one or more textual reports associated with the one or more electronic health records. In various embodiments of the invention, the textual reports may be analyzed using one or more text mining techniques, such as text classification and text clustering, to extract the information. Similarly, data mining module 122 extracts information from structured data associated with the one or more electronic health records. In various embodiments of the invention, the structured data may include but not limited to administrative data, such as billing information, patient schedules, and discharge summary reports.

Data in repository 104 may be classified into different categories using data classification module 108. The classified data may then be used by mining module 102 to extract information. Data classification module 108 enables the user to define a set of preferences for classifying the data based on metadata. In particular, the plurality of images may be classified based on the metadata stored in the DICOM format. For example, the user may specify the value of DICOM attribute ‘Modality’ as ‘Magnetic Resonance Imaging (MRI)’. Accordingly, the images that have the value of DICOM attribute ‘Modality’ set to ‘MRI’ are classified under this category. Subsequently, the preferences defined by the user through data classification module 108 may be stored in configuration module 114 for future references. Mining module 102 may then extract information from the classified data. Further, one or more rules may be defined using configuration module 114 for configuring CDM system 100. For example, configuration module 114 may be used to configure text mining module 120 or image mining module 118. For example, image mining module 118 may be configured using configuration module 114 to identify the one or more images based on predefined criteria such as ‘texture’, ‘shape’ and ‘color’. Further, configuration module 114 may also be used to assign weights to the predefined criteria according to their relative importance in identifying the images.

Thereafter, knowledge generation module 106 generates one or more reports based on the extracted information to enable the user to analyze the information. The generated reports may include one or more charts, one or more data summary reports or one or more statistical reports. In another embodiment of the invention, the reports may be generated based on the extracted information and the knowledge accumulated in the repository over a period of time. For example, the reports may be generated based on the extracted information and knowledge derived by the user over a period of one year. Subsequently, knowledge is derived by the user based on the analysis. The derived knowledge may then be used for clinical research, drug discovery or medical diagnosis. The derived knowledge may also be stored in repository 104. In another embodiment of the invention, knowledge generation module 106 may be a knowledge-based system that employs one or more inference mechanisms. The inference mechanisms may include one or more rules, one or more decision trees and domain ontology to exploit the accumulated knowledge for making intelligent decisions.

Data export module 110 may be used for exporting a first set of data from repository 104. The first set of data may include the knowledge derived by the user, knowledge accumulated in repository 104 over a period of time, the data stored in repository 104 or the reports generated by knowledge generation module 106. Similarly, a second set of data may be imported into repository 104 using data import module 112. The second set of data may include the knowledge derived by a medical expert or the information extracted from one or more external sources, for example, Hospital Information System (HIS) and Picture Archival and Communication System (PACS). The information obtained from the external sources may be converted into a common format by using a data warehousing technique, for example, Extraction Transformation Loading (ETL), before being imported into repository 104.

In another embodiment of the invention, a workflow manager interacts with CDM system 100 to perform one or more specific data mining tasks such as disease management, evidence retrieval, and quality management. The workflow manager enables the user to create one or more workflows to perform the data mining tasks.

Thus, a data mining system similar to CDM system 100 may be used to derive knowledge in various domains such as retail, media and publishing, crime detection, and satellite imaging. For example, CDM system 100 may be used for diagnostic studies or generating epidemic alerts in a healthcare environment.

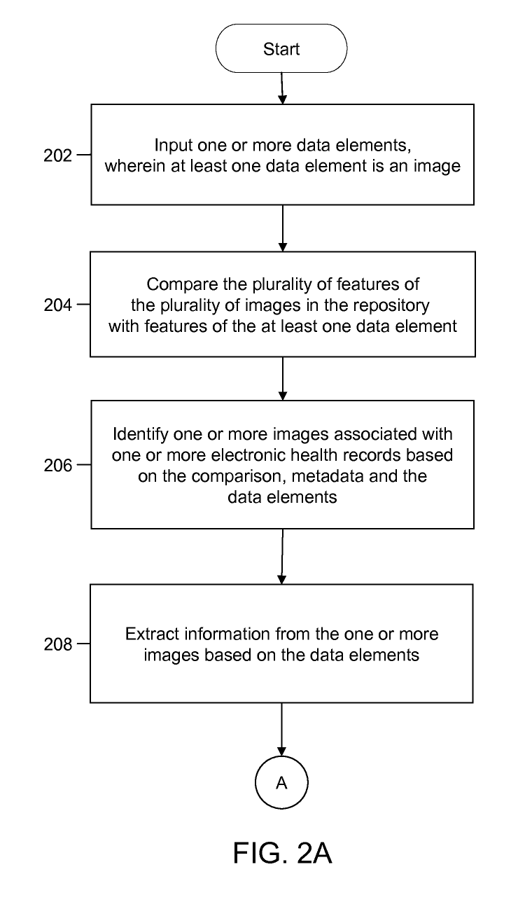

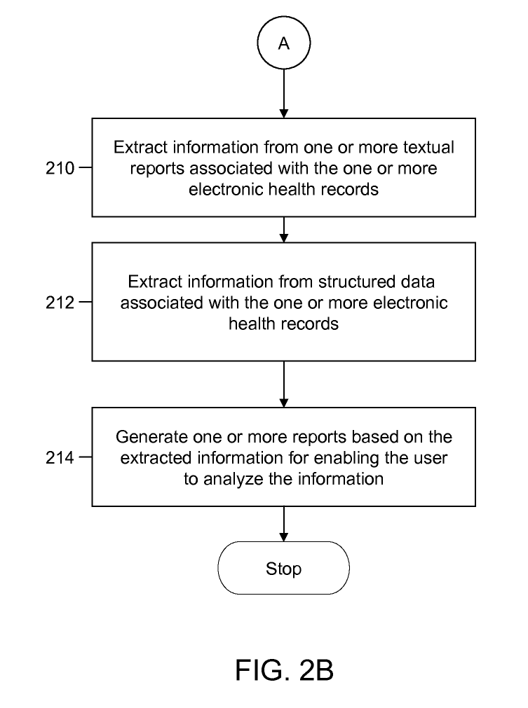

FIGS. 2A and 2B illustrate a method for performing clinical data mining to derive knowledge from data stored in a repository, such as repository 104, in accordance with another embodiment of the invention.

In various embodiments of the invention, a plurality of features may be extracted from the plurality of images and stored in a feature repository. The plurality of features may then be used to index the plurality of images. For example, features, such as intensity, texture, and shape, may be extracted from the images and subsequently used to index the images. At 202, one or more data elements are inputted by the user, wherein at least one data element is an image. At 204, the plurality of features are compared with features of the at least one data element. At 206, one or more images associated with one or more electronic health records are identified from the plurality of images based on the comparison. In various embodiments of the invention, the images are identified based on at least one of metadata, the data elements, and the comparison. For example, the data elements may include a sample image and one or more criteria. The one or more criteria may include values corresponding to one or more DICOM attributes, for example, a value corresponding to a DICOM attribute ‘Organ’ may be defined as ‘Heart’. Subsequently, the plurality of features may be compared with the features of the sample image. The DICOM attributes of the plurality of images may then be compared with the criteria. Accordingly, the one or more images may be identified based on the comparisons. In another embodiment of the invention, the data elements may not include any image. In this case, the data elements may only include textual reports or one or more criteria that may correspond to metadata or image features. Accordingly, the images may be identified based on associated metadata and the data elements.

At 208, information is extracted from the identified images based on the data elements. For example, one or more dimensions of a brain tumor in the images may be extracted. At 210, information is extracted from one or more textual reports associated with the one or more electronic health records. At 212, information is extracted from structured data associated with the one or more electronic health records. Thereafter, at 214, one or more reports are generated based on the extracted information to enable the user to analyze the information for deriving knowledge such as hidden patterns and new insights that may aid the user in medical diagnosis or clinical research. The reports may include one or more charts, summary reports, and statistical reports. In another embodiment of the invention, knowledge that has been accumulated in the repository over a period of time may also be used to generate the reports.

In yet another embodiment of the invention, the textual reports may be identified based on the data elements. In other words, metadata associated with the textual reports may be compared with the data elements to identify the textual reports. Further, the one or more images may be identified based on the electronic health records associated with the textual reports. In various embodiments of the invention, the electronic health records are associated with a unique identifier that may be used to identify the data associated with them.

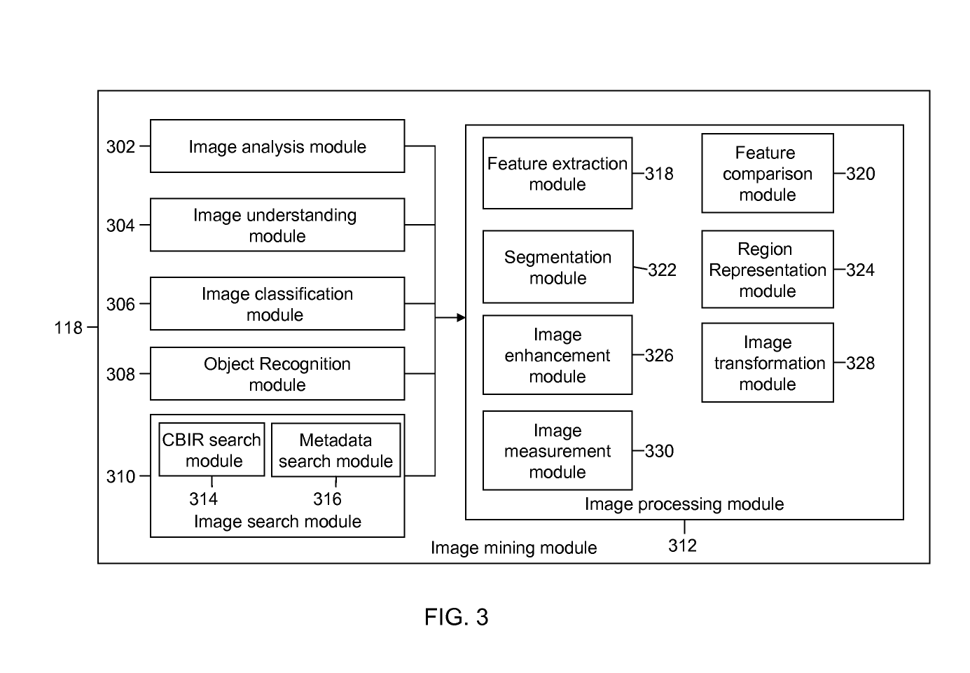

FIG. 3 illustrates a block diagram of image mining module 118, in accordance with an embodiment of the invention. Image mining module 118 may include various modules such as an image analysis module 302, an image understanding module 304, an image classification module 306, an object recognition module 308, an image search module 310, and an image processing module 312. Image search module 310 includes a CBIR search module 314 and a metadata search module 316. Image processing module 312 includes a feature extraction module 318, a feature comparison module 320, a segmentation module 322, a region representation module 324, an image enhancement module 326, an image transformation module 328 and an image measurement module 330.

Image analysis module 302 extracts information from one or more images using image processing module 312. Image processing module 312 processes the identified images based on one or more image processing techniques. For example, image analysis module 302 may measure the size of a brain tumor in an MRI scan of the brain. Further, image understanding module 304 may provide descriptive information about the MRI scan based on one or more configurations. For example, the descriptive information may be provided based on predefined criteria such as shape, texture, and intensity. In addition, object recognition module 308 may identify an object or a region of interest in the images by comparing the images with a predefined specification of the object, such as object features or dimensions. The comparison may be performed on the basis of features of the images that may be extracted using feature extraction module 318.

Feature extraction module 318 extracts the features from the plurality of images stored in repository 104. In various embodiments of the invention, the DICOM attributes of the images are parsed and image data is extracted. The features are then extracted from the image data. The features may include one or more texture, shape and color descriptors. Further, the features may be stored in a feature repository and may be used to index the images. In another embodiment of the invention, one or more vectors or histograms may be created based on the features and may then be stored in the feature repository.

Image search module 310 enables the user to search images from repository 104. In particular, CBIR search module 314 enables the user to search images based on image features such as shape and color. Similarly, metadata search module 316 enables the user to search images based on image metadata such as DICOM attributes corresponding to the images.

In an embodiment of the invention, the data elements may include a sample image. Feature comparison module 320 compares the extracted features of the images with features of the sample image. In addition, the data elements may also include one or more criteria based on image metadata. Accordingly, metadata search module 316 may extract DICOM metadata from the images. The metadata may then be compared with the criteria. The one or more images may then be identified based on the comparisons. Feature comparison module 320 may also assign scores to the identified images based on the comparisons. The user may also define one or more regions in the sample image using region representation module 324 and the images may be identified based on the defined regions. For example, a left frontal region of a brain MRI scan may be defined and the images may be identified by comparing features of the left frontal region and the extracted features of the images stored in repository 104.

In another embodiment of the invention, the plurality of images may be classified using image classification module 306. The images may be classified based on a set of preferences corresponding to the metadata of the images. The one or more images may then be identified based on the classification. As data may be only extracted from the classified images, image processing and data extraction time may be reduced.

Image analysis module 302 may then analyze information in the one or more images. Segmentation module 322 may partition the images into one or more regions of interest based on color, intensity or texture attributes. In another embodiment of the invention, image enhancement module 326 may pre-process the image using one or more image enhancement techniques such as edge enhancement, contrast stretching, histogram equalization and noise reduction. The image enhancement techniques may vary according to the organ and modality corresponding to the images. In addition, image transformation module 328 may enable spatial transformations such as translation, scaling and rotation of the images for enabling the user to visualize the images and enable further processing. Further, image measurement module 330 may measure one or more dimensions of the images. For example, image measurement module 330 may measure the dimension of a bone fracture in an X-ray image of a hand. This may then be used to identify the images or extract information from the images.

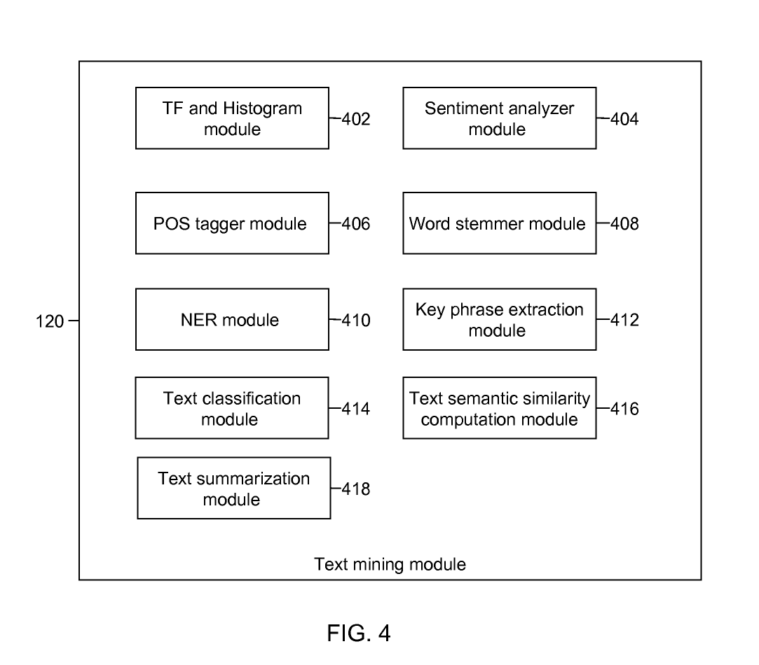

FIG. 4 illustrates a block diagram of text mining module 120, in accordance with an embodiment of the invention. Text mining module 120 may include various modules such as a Term Frequency (TF) and histogram module 402, a sentiment analyzer module 404, a Parts of Speech (POS) tagger module 406, a word stemmer module 408, a Named Entity Recognition (NER) module 410, a key phrase extraction module 412, a text classification module 414, a text semantic similarity computation module 416, and a text summarization module 418.

Text mining module 120 extracts information from the textual reports stored in repository 104. Text mining module 120 employs one or more text mining techniques to process the textual reports to extract information. Some of these techniques may include, but not limited to, TF and histogram analysis, sentiment analysis, key phrase extraction and text semantic similarity computation.

TF and histogram module 402 calculates frequency of one or more terms in the textual reports. The frequency may be used as an indicator of importance of the terms in the textual reports. Sentiment analyzer module 404 extracts sentiment about a subject from the textual reports. For example, sentiment analyzer module 404 may extract the nature of feedback provided by a patient in a healthcare environment. The extracted nature of feedback may then be used for quality management. POS tagger module 406 identifies the part of speech, of words, for example, a noun or adjective in the textual reports. Further, word stemmer module 408 extracts root words of one or more words in the textual reports. Also, NER module 410 tags the words using predefined entities such as body temperature, age of a patient, blood pressure, and sugar level. Similarly, key phrase extraction module 412 extracts one or more keywords from the textual reports. The keywords are extracted on the basis of inputs provided by the user and may be used by text semantic similarity computation module 416 and text summarization module 418. Text classification module 414 classifies the textual reports based on metadata inputted by the user. Further, text semantic similarity computation module 416 compares the semantics of textual reports and determines the extent of similarity between them. Furthermore, text summarization module 418 summarizes the text in the textual reports based on the data elements.

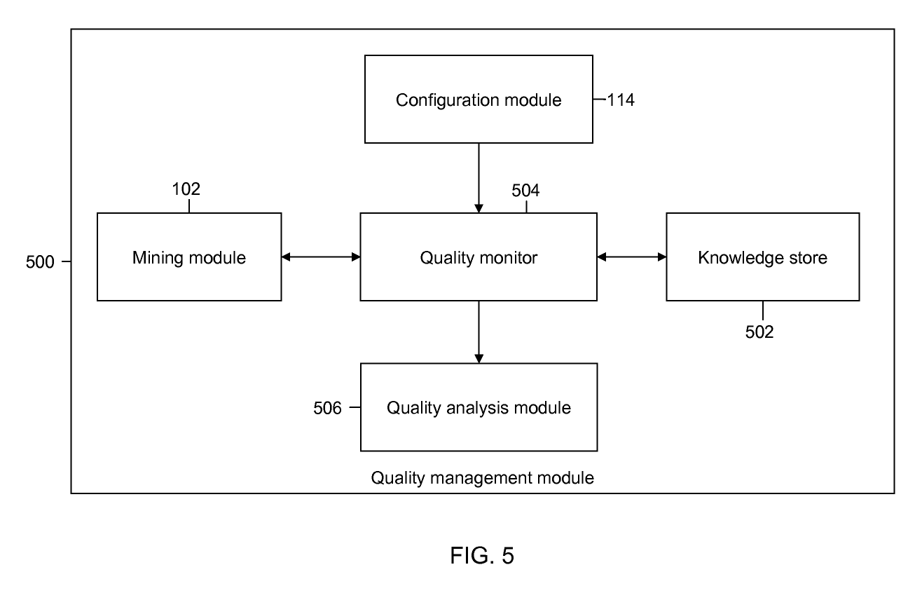

FIG. 5 illustrates a block diagram of a quality management module 500, in accordance with an embodiment of the invention. Quality management module 500 includes mining module 102, configuration module 114, a knowledge store 502, a quality monitor 504, and a quality analysis module 506.

Quality management module 500 executes a workflow for performing a specific data mining task of managing quality based on one or more rules pertaining to a desired quality level of the healthcare environment. Information associated with the electronic health records may be extracted and quality may be assessed on the basis of the rules. The rules may refer to one or more quality standards, clinical and operational guidelines, and best practices. Configuration module 114 may store the rules. Mining module 102 analyzes the structured data, such as patient schedules and discharge summary reports, to retrieve patient information. Mining module 102 also uses one or more text mining techniques, such as sentiment analysis, to analyze feedback provided by one or more patients.

On the basis of the rules and the analysis, quality monitor 504 evaluates one or more practices of the medical experts and measures their performance for quality assessment. Their performance may be measured against one or more quality benchmarks stored in configuration module 114. Further, knowledge store 502 may store historical information such as one or more historical quality records and historical patient feedback. Based on the historical records and evaluation performed by quality monitor 504, quality analysis module 506 may provide an analysis to the medical experts, for example, a performance improvement plan, to improve quality. Quality analysis module 506 may also generate a patient satisfaction quotient based on the feedback. In addition, a warning may be generated when the patient satisfaction quotient is below a predefined standard.

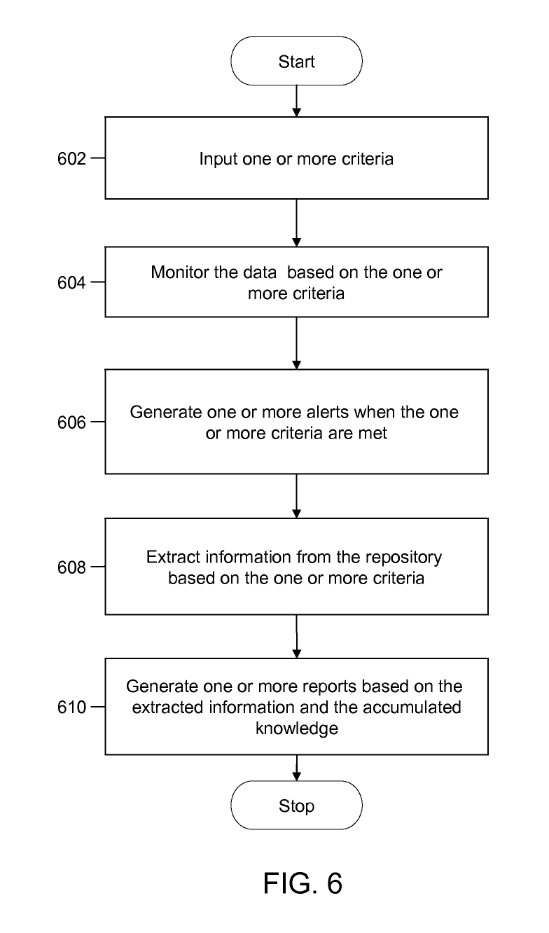

FIG. 6 illustrates a flowchart of a workflow of a biosurveillance agent for monitoring data stored in a repository, such as repository 104, of a clinical data mining system, such as CDM system 100, in accordance with an embodiment of the invention. At 602, one or more criteria are inputted by the user. Examples of criteria may include, but not limited to, a number of patients, a time frame, severity of a disease, and one or more user alert options. At 604, the biosurveillance agent monitors the data based on the criteria. At 606, one or more alerts are generated when the criteria are met. For example, the criteria may be defined as a number of patients afflicted with a certain disease. When the criteria are met, an alert indicating an outbreak of an epidemic may be provided to the user. Thereafter, at 608, the biosurveillance agent triggers the clinical data mining system to extract information from the repository based on the criteria. The information may include a set of evidence on the basis of which the user alert is generated. Subsequently, at 610, one or more reports are generated based on the information.

In yet another embodiment of the invention, a workflow may be created for performing another data mining task of evidence retrieval. The user may provide a sample electronic health record, which may include one or more images, textual reports or structured data. The clinical data mining system may then retrieve similar electronic health records by comparing at least one of metadata and image features. The user may also specify one or more regions of interest in the images of the sample electronic health record based on which similar electronic health records may be identified. In addition, the user may define one or more parameters, for example, modality information, to identify similar electronic health records. Further, the parameters may be stored in a configuration server such as configuration module 114. In another embodiment of the invention, the clinical data mining system may assign scores to the records based on their degree of similarity.

In still another embodiment of the invention, a workflow may be created to extract all information associated with one or more electronic health records. The workflow may monitor the data in the repository and extract information periodically as defined by the user. The information may be used by an amateur medical practitioner to understand the data associated with the electronic health records. Similarly, in another embodiment of the invention, a workflow may be created for managing healthcare requirements of one or more patients. Data corresponding to medical history of the patients may be extracted. Based on the medical history and one or more parameters, such as age, gender, chronic condition of the patients, one or more medical experts may then suggest healthcare plans for the patients. The healthcare plans may include practices to enable self-managed healthcare and scheduled meetings with the medical experts. Additionally, the workflow may also generate reports detailing the progress of the patients based on the healthcare plans.

In addition, workflows may also be created to perform specific data mining tasks, such as analyzing the trend of healthcare operations, evaluating diagnostic decisions, and indicating prognosis of one or more diseases.

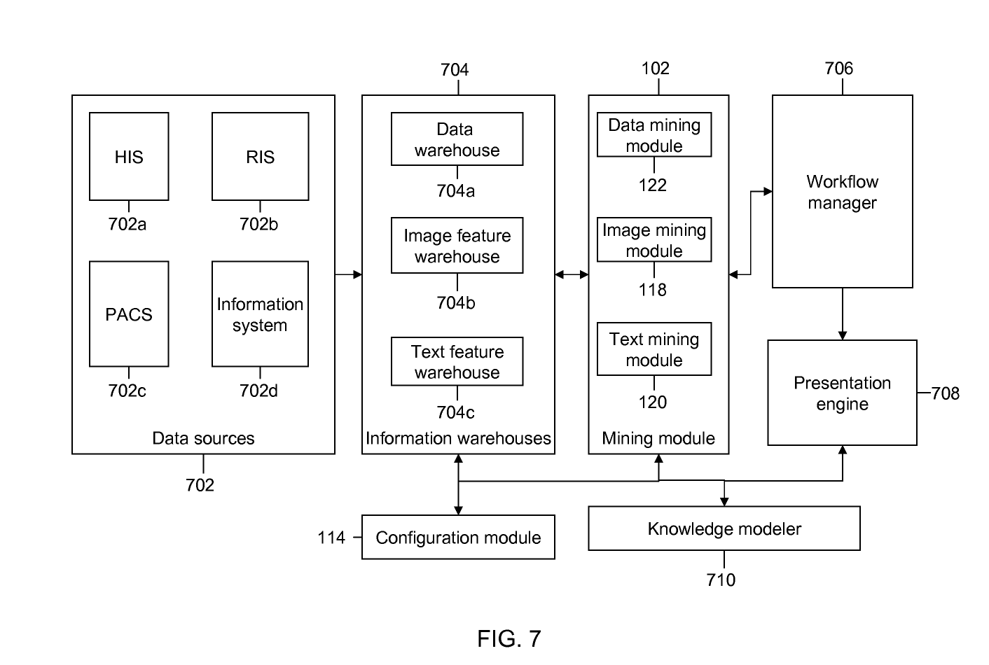

FIG. 7 illustrates an exemplary architecture of a clinical data mining system such as CDM system 100, in accordance with an embodiment of the invention. FIG. 7 includes a plurality of data sources such as HIS 702a, Radiology Information Systems (RIS) 702b, PACS 702c, and information system 702d, hereinafter referred to as data sources 702; a plurality of information warehouses such as a data warehouse 704a, an image feature warehouse 704b, and a text feature warehouse 704c, hereinafter referred to as information warehouses 704; mining module 102; a workflow manager 706; a presentation engine 708; a knowledge modeler 710; and configuration module 114. Mining module 102 includes image mining module 118, text mining module 120, and data mining module 122.

Data sources 702 store data including structured and unstructured data related to a plurality of electronic health records. For example, PACS 702c stores images such as x-ray images. Similarly, RIS 702b may store patient radiology information gathered from various radiology departments and imaging centers. The data from data sources 702 is mapped to a common format using a data warehousing technique such as ETL. Thereafter, data along with one or more features extracted from the electronic health records is stored in information warehouses 704. Mining module 102 may extract the features from one or more images and one or more textual reports associated with the electronic health records based on a set of predefined features such as shape and intensity. Subsequently, the features extracted from the images are stored in image feature warehouse 704b. Similarly, the features extracted from the textual reports are stored in text feature warehouse 704c. The data associated with the electronic health records, i.e., the images, the textual reports, and the structured data, is stored in data warehouse 704a.

Mining module 102 also extracts information from data stored in information warehouses 704 to enable the user to derive knowledge. Workflow manager 706 enables the user to create one or more workflows to perform one or more specific data mining tasks such as evidence retrieval and quality management. Presentation engine 708 enables the user to use the workflows to perform the data mining tasks. Further, one or more workflow configurations, such as criteria defined by the user to monitor data in information warehouses 704, are stored in configuration module 114.

Knowledge modeler 710 stores the knowledge derived by the user through clinical data mining. Knowledge modeler 710 may be a knowledge-based system that employs one or more reasoning mechanisms, such as rules and decision trees, to leverage the derived knowledge to make intelligent decisions.

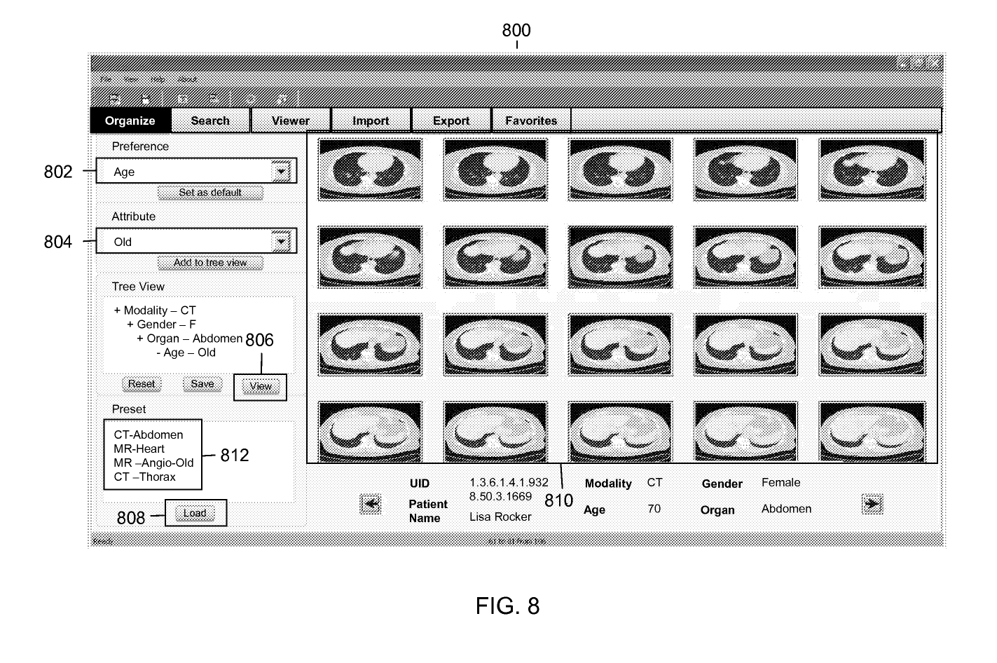

FIG. 8 is a screenshot 800 of an exemplary user interface of data classification module, such as data classification module 108, in accordance with an embodiment of the invention. Screenshot 800 includes a plurality of drop-down menus such as a drop-down menu 802 and a drop-down menu 804, a plurality of buttons such as buttons 806 and 808, and an image view panel 810.

The user may select a criterion from a list of criteria reflecting in drop-down menu 802. The criterion may include one or more DICOM attributes. The value corresponding to the selected criterion may then be selected from drop-down menu 804. For example, the user may select the criterion as ‘Age’ and a corresponding value as ‘Old’. As the user clicks on button 806, one or more images that have the defined value for the selected criterion are displayed in image view panel 810. Thus, the displayed images are classified under a category defined by the criterion and its corresponding value. The user may also create similar categories.

Further, the categories may be stored in configuration module 114. The user may enter a category from a list of categories, depicted by 812 in FIG. 8, by clicking on button 808. The images classified under the specified category may then be displayed in image view panel 810.

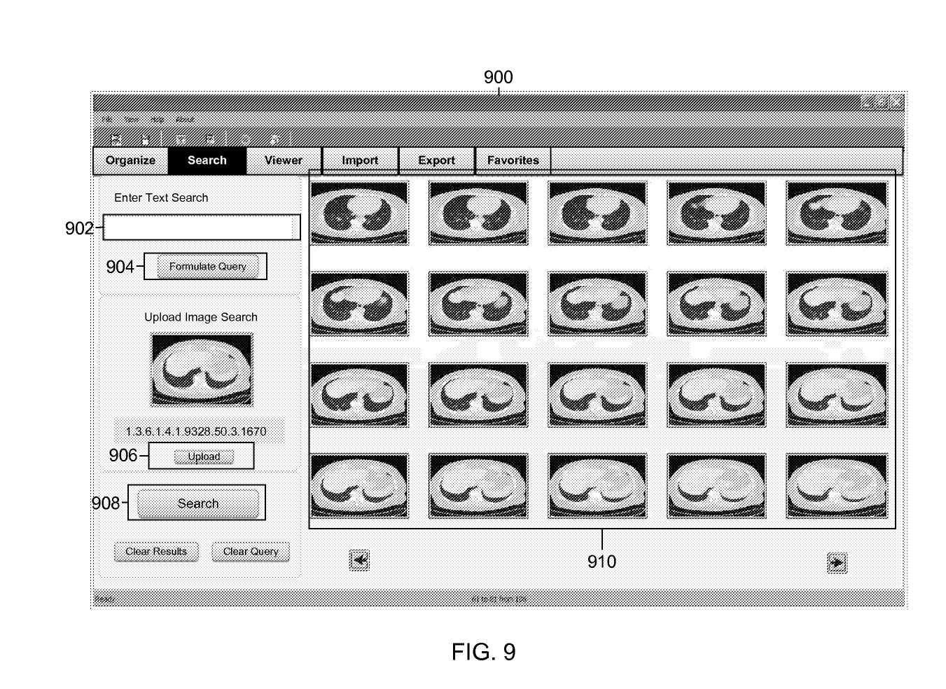

FIG. 9 is a screenshot 900 of an exemplary user interface of a system for searching images, in accordance with another embodiment of the invention. Screenshot 900 includes a textbox 902; a plurality of buttons such as buttons 904, 906, and 908; and an image view panel 910. The user may click on button 904 to formulate a text query based on metadata to search the images. For example, the user may define a text query including values corresponding to one or more DICOM attributes such as ‘Age’ and ‘Organ’. The formulated query may then be reflected in textbox 902. The user may also upload a sample image by clicking on button 906. Further, as the user clicks on button 908, one or more images are reflected in image view panel 910. Thus, the images are identified on the basis of the text query and the sample image.

The method and clinical data mining system have a number of advantages. As information is extracted from images, textual reports, and structured data associated with the electronic health records, knowledge is derived from all forms of structured and unstructured data. Further, data can be imported from existing database systems, such as HIS and RIS, to access one or more historical medical records. Furthermore, knowledge derived by the user over a period of time may also be stored and accessed for discovering insights. Also, the data may be accessed on the basis of one or more criteria such as image regions or metadata. In addition, workflows may be created to perform key data mining needs such as quality management, evidence retrieval, and biosurveillance.

The clinical data mining system, as described in the present invention or any of its components, may be embodied in the form of a computer system. Typical examples of a computer system include a general-purpose computer, a programmed microprocessor, a microcontroller, a peripheral integrated circuit element, and other devices or arrangements of devices that are capable of implementing the steps that constitute the method of the present invention.

The computer system comprises a computer, an input device, a display unit, and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive, such as a floppy disk drive and an optical disk drive. The storage device can also be other similar means for loading computer programs or other instructions into the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device, which enable the computer system to connect to databases and networks, such as Local Area Network (LAN), Metropolitan Area Network (MAN), Wide Area Network (WAN), and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for performing clinical data mining to enable a user to derive knowledge from data stored in a repository. The computer program product includes a computer usable medium having a set program instructions comprising a program code for performing clinical data mining to enable the user to derive knowledge from data stored in the repository. The set of instructions may include various commands that instruct the processing machine to perform specific tasks, such as the steps that constitute the method of the present invention. The set of instructions may be in the form of a software program. Further, the software may be in the form of a collection of separate programs, a program module with a large program or a part of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions, and equivalents will be apparent to those skilled in the art without departing from the spirit and scope of the invention, as described in the claims.

What is claimed is:

1. A clinical data mining system for enabling a user to derive knowledge from data corresponding to a plurality of electronic health records stored in a repository, the system suitable for use in a healthcare environment, the system comprising:
a. an image mining module configured for extracting information from one or more images associated with one or more electronic health records from the plurality of electronic health records, the information being extracted based on one or more data elements provided as an input;
b. a text mining module configured for extracting information from one or more textual reports associated with the one or more electronic health records, the information being extracted based on the one or more data elements;
c. a data mining module configured for extracting information from structured data associated with the one or more electronic health records; and
d. a knowledge generation module configured for generating one or more reports based on the extracted information, the one or more reports being generated for enabling the user to analyze the information, wherein knowledge is derived based on the analysis.

2. The clinical data mining system according to claim 1, wherein the image mining module comprises an image search module configured for identifying the one or more images from a plurality of images stored in the repository, the one or more images being identified based on the one or more data elements and at least one of metadata and one or more features corresponding to the one or more images.

3. The clinical data mining system according to claim 2, wherein the image search module uses one or more image processing techniques for identifying the one or more images.

4. The clinical data mining system according to claim 2, wherein at least one data element from the one or more data elements is an image.

5. The clinical data mining system according to claim 4 further comprising a feature extraction module configured for extracting a plurality of features from the plurality of images.

6. The clinical data mining system according to claim 5 further comprising a feature comparison module configured for comparing the plurality of features with features of the at least one data element, wherein the image search module identifies the one or more images based on the comparison.

7. The clinical data mining system according to claim 6, wherein the feature comparison module is further configured for assigning one or more scores to the one or more images based on the comparison.

8. The clinical data mining system according to claim 7 further comprising a relevance feedback module for enabling the user to provide a feedback on the assigned scores.

9. The clinical data mining system according to claim 5, wherein the feature extraction module is further configured for storing the plurality of features in the repository.

10. The clinical data mining system according to claim 4, wherein the image mining module is further configured for enabling the user to specify one or more regions in the at least one data element, the one or more images being identified based on the one or more regions.

11. The clinical data mining system according to claim 1 further comprising a data classification module configured for classifying the data based on a set of preferences, wherein the information is extracted based on the classification.

12. The clinical data mining system according to claim 1 further comprising a data export module configured for exporting a first set of data from the repository to an external storage device.

13. The clinical data mining system according to claim 1 further comprising a data import module configured for importing a second set of data into the repository.

14. The clinical data mining system according to claim 1, wherein the derived knowledge is stored in the repository.

15. The clinical data mining system according to claim 1, wherein the one or more images and the one or more textual reports are indexed with features of the one or more data elements.

16. The clinical data mining system according to claim 1, wherein a workflow manager interacts with the clinical data mining system for performing one or more specific data mining tasks, the workflow manager enabling the user to create one or more workflows for performing the one or more specific data mining tasks.

17. A method for performing clinical data mining to enable a user to derive knowledge from data corresponding to a plurality of electronic health records stored in a repository, the method suitable for use in a healthcare environment, the method comprising:
a. extracting information from one or more images associated with one or more electronic health records from the plurality of electronic health records, the information being extracted based on one or more data elements provided as an input;
b. extracting information from one or more textual reports associated with the one or more electronic health records, the information being extracted based on the one or more data elements;
c. extracting information from structured data associated with the one or more electronic health records; and
d. generating one or more reports based on the extracted information, the one or more reports being generated for enabling the user to analyze the information, wherein knowledge is derived based on the analysis.

18. The method according to claim 17, wherein the one or more images are identified from a plurality of images stored in the repository, the one or more images being identified based on the one or more data elements and at least one of metadata and one or more features corresponding to the one or more images.

19. The method according to claim 18, wherein the one or more images are identified using one or more image processing techniques.

20. The method according to claim 18, wherein at least one data element from the one or more data elements is an image.

21. The method according to claim 20 further comprising extracting a plurality of features from the plurality of images.

22. The method according to claim 21 further comprising comparing the plurality of features with features of the at least one data element for identifying the one or more images.

23. The method according to claim 22 further comprising assigning one or more scores to the one or more images based on the comparison.

24. The method according to claim 23 further comprising enabling the user to provide a feedback on the assigned scores.

25. The method according to claim 21 further comprising storing the plurality of features in the repository.

26. The method according to claim 20 further comprising enabling the user to specify one or more regions in the at least one data element, the one or more images being identified based on the one or more regions.

27. The method according to claim 17 further comprising classifying the data based on a set of preferences, wherein the information is extracted based on the classification.

28. The method according to claim 17 further comprising exporting a first set of data from the repository to an external storage device.

29. The method according to claim 17 further comprising importing a second set of data into the repository.

30. The method according to claim 17, wherein the derived knowledge is stored in the repository.

31. The method according to claim 17 further comprising indexing the one or more images and the one or more textual reports with features of the one or more data elements.

32. The method according to claim 17, wherein one or more workflows are created for performing one or more specific data mining tasks.

33. A computer program product for use with a computer, the computer program product comprising a computer usable medium having a computer readable program code embodied therein for performing clinical data mining to enable a user to derive knowledge from data corresponding to a plurality of electronic health records stored in a repository, the computer program product suitable for use in a healthcare environment, the computer readable program code performing:
a. extracting information from one or more images associated with one or more electronic health records from the plurality of electronic health records, the information being extracted based on one or more data elements provided as an input;
b. extracting information from one or more textual reports associated with the one or more electronic health records, the information being extracted based on the one or more data elements;
c. extracting information from structured data associated with the one or more electronic health records; and
d. generating one or more reports based on the extracted information, the one or more reports being generated for enabling the user to analyze the information, wherein knowledge is derived based on the analysis.

34. The computer program product according to claim 33, wherein the one or more images are identified from a plurality of images stored in the repository, the one or more images being identified based on the one or more data elements and at least one of metadata and one or more features corresponding to the one or more images.

35. The computer program product according to claim 34, wherein at least one data element from the one or more data elements is an image.

36. The computer program product according to claim 35, wherein the computer readable program code further performs extracting a plurality of features from the plurality of images.

37. The computer program product according to claim 36, wherein the computer readable program code further performs comparing the plurality of features with features of the at least one data element for identifying the one or more images.

38. The computer program product according to claim 37, wherein the computer readable program code further performs assigning one or more scores to the one or more images based on the comparison.

39. The computer program product according to claim 38, wherein the computer readable program code further performs enabling the user to provide a feedback on the assigned scores.

40. The computer program product according to claim 36, wherein the computer readable program code further performs storing the plurality of features in the repository.

41. The computer program product according to claim 35, wherein the computer readable program code further performs enabling the user to specify one or more regions in the at least one data element, the one or more images being identified based on the one or more regions.

42. The computer program product according to claim 33, wherein the computer readable program code further performs classifying the data based on a set of preferences, information being extracted based on the classification.

43. The computer program product according to claim 33, wherein the computer readable program code further performs exporting a first set of data from the repository to an external storage device.

44. The computer program product according to claim 33, wherein the computer readable program code further performs importing a second set of data into the repository.

45. The computer program product according to claim 33, wherein the computer readable program code further performs indexing the one or more images and the one or more textual reports with features of the one or more data elements.

46. The computer program product according to claim 33, wherein the computer readable program code further performs enabling the user to create one or more workflows for performing one or more specific data mining tasks.
